(19) United States
(12) Patent Application Publication
(10) Pub. No.: US 2026/0362318 A1
(43) Pub. Date: Nov. 12, 2026

(54) ENERGY CONSUMPTION MANAGEMENT METHOD AND SYSTEM THEREOF FOR A SMALL CELL

(71) Applicant: LITE-ON TECHNOLOGY CORPORATION, Taipei (JP)

(72) Inventor: Pei-Hsuan LIN, Taipei (TW)

(21) Appl. No.: 19/561,591

(22) Filed: Mar. 10, 2026

Related U.S. Application Data
(60) Provisional application No. 63/802,739, filed on May 9, 2025.

(30) Foreign Application Priority Data
Jan. 30, 2026 (CN) 202610132521.5

(51) Int. Cl. H04W 52/02; H04W 28/086

(52) U.S. Cl. CPC H04W 52/0206; H04W 28/0861

(57) ABSTRACT

The present application provides an energy consumption management method and system for a small cell. The energy consumption management system of the small cell is communicatively connected to a plurality of small cells. The energy consumption management system comprises: a radio access network intelligent controller, comprising an energy consumption management application; and a wireless network management platform, communicatively connected to the radio access network intelligent controller or the energy consumption management application. The energy consumption management application receives a plurality of indicator data of the plurality of small cells to calculate a load parameter of the plurality of small cells, and weights the load parameter to respectively calculate a plurality of overall load parameters of the plurality of small cells, whereby the energy consumption management application controls the corresponding plurality of small cells to enter an energy-saving state according to each of the overall load parameters.

This application claims the benefit of U.S. provisional Patent Application Ser. No. 63/802,739 filed 2025 May 9 and China Patent application Serial No. 202610132521.5, filed 2026 Jan. 30, the disclosure of which is incorporated by reference herein in its entirety.

### TECHNICAL FIELD

The present disclosure relates to an energy consumption management method and system thereof for a small cell.

### BACKGROUND

With the rapid popularization and widespread deployment of 5G networks, the energy consumption of the global telecommunications industry has significantly increased accordingly. Particularly in the Radio Access Network (RAN), the energy consumed by base stations (gNB, gNodeB) accounts for an extremely high proportion. Since small cells are deployed in large numbers in high-density urban areas, indoor venues, and edge network environments, the dense topology formed, while improving quality of service and transmission efficiency, simultaneously brings more severe energy management challenges.

Currently, most energy-saving strategies adopted by the industry are passive and based on simplified conditions. For instance, judgments are made based on the number of connected user equipments (UEs) at a single point in time or real-time data transmission rates as the basis for entering an energy-saving mode. However, these traditional indicators cannot effectively reflect the true state of the overall network load, especially in 5G networks where load characteristics are highly variable and time-sensitive. For example, certain low-data-rate but latency-sensitive applications (such as the Internet of Things (IoT) or voice services based on new radio access technology (5G voice calls) (Voice over New Radio, VoNR)) may show flat performance in terms of traffic but still impose a substantial load on base station operations. Conversely, short-term peak traffic may subside before the system automatically detects and switches.

Therefore, traditional energy-saving strategies are prone to the following two situations: (1) entering a low-power mode prematurely, leading to increased user connection latency or service interruption; (2) missing the optimal timing for energy-saving, resulting in unnecessary energy waste. The aforementioned problems all reflect that current methods lack accurate, predictable, and intelligent energy management capabilities.

To solve the above problems, the present application proposes an artificial intelligence-driven multi-dimensional energy management system. Its core lies in establishing an intelligent decision-making architecture that can analyze, predict, and control base station energy usage in real-time.

### SUMMARY

The present disclosure relates to an energy consumption management method and system thereof for a small cell. The energy consumption management method for a small cell of the present disclosure and the energy consumption management system for a small cell applying the same integrate the following three major technical dimensions. (1) Real-time Data Analytics: A complete real-time operational picture is established by collecting operational parameters from each small cell, such as UE connection status, traffic characteristics, resource allocation scenarios, and antenna usage. (2) Machine Learning Algorithms: Models are trained using historical data to predict load trends and user behavior in the short-term future, thereby performing energy consumption adjustments in advance. For example, it can predict which base stations can enter an energy-saving mode during non-peak hours. (3) Environmental Sensing Integration: This system can also be combined with external environmental sensors (such as temperature, humidity, pedestrian flow, space usage conditions, etc.) to further strengthen the judgment of space usage scenarios and improve the accuracy of energy decisions.

According to one embodiment, an energy consumption management method for a small cell is provided. The energy consumption management method comprises: receiving a plurality of indicator data of the small cell; calculating a load parameter; performing numerical normalization and weighting based on the load parameter to calculate an overall load parameter; and controlling the small cell to enter an energy-saving state according to the overall load parameter. Wherein the load parameter comprises at least one of: a physical resource block (PRB) usage rate indicator calculated according to an uplink PRB usage rate and a downlink PRB usage rate of the small cell; a service load indicator calculated according to current throughput data and historical throughput data of the small cell; a field load indicator calculated according to a user equipment connection ratio and a service area ratio; and an additional indicator calculated according to a total transmit power ratio, a service time ratio, and a handover availability parameter.

According to another embodiment, provided is a small cell energy consumption management system communicatively connected to a plurality of small cells. The energy consumption management system comprises: a radio access network intelligent controller, comprising an energy consumption management application; and a wireless network management platform, communicatively connected to the radio access network intelligent controller or the energy consumption management application. Wherein the energy consumption management application receives a plurality of indicator data of the plurality of small cells to calculate a load parameter of the plurality of small cells, and weights the load parameter to respectively calculate a plurality of overall load parameters of the plurality of small cells, whereby the energy consumption management application controls the corresponding plurality of small cells to enter an energy-saving state according to each of the overall load parameters.

### BRIEF DESCRIPTION OF THE DRAWINGS

FIG. 1 illustrates a functional block diagram of an energy consumption management system for a small cell according to an embodiment of the present application.

FIG. 2 illustrates a diagram of an energy consumption management system for a small cell according to another embodiment of the present application.

FIG. 3 shows a flowchart of an energy consumption management method for a small cell according to an embodiment of the present application.

FIG. 4 shows a schematic diagram of energy-saving of a small cell according to an embodiment of the present application.

FIG. 5 shows a functional block diagram of an energy consumption management system for a small cell according to an embodiment of the present application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification are interpreted in accordance with the customary usage in the relevant technical field. Where certain terms are specifically explained or defined in this specification, the explanations or definitions provided herein shall prevail. Each embodiment of the present disclosure includes one or more technical features. Provided that implementation is feasible, a person having ordinary skill in the art may selectively implement some or all of the technical features of any embodiment, or selectively combine some or all of the technical features of these embodiments.

In modern wireless communication systems (such as 5G Radio Access Networks), the operational status and load conditions of base stations are highly dynamic and complex. Relying solely on a single indicator (such as the number of UEs or real-time throughput) as the basis for judging base station load or performance is prone to distortion, misjudgment, or delayed response, and fails to accurately reflect the actual operational conditions of the system.

To this end, the present disclosure proposes a more comprehensive analysis method, namely, performing load assessment and system management by simultaneously monitoring multiple resource utilization and performance indicators. Specifically, the monitored indicators may include, for example but not limited to, Resource Utilization Indicators and Performance Metrics.

Resource utilization indicators may include, for example but not limited to: (1) Physical Resource Block (PRB) usage, representing the actual usage of wireless spectrum resources and reflecting the load density of the base station in time and frequency dimensions; and (2) Number of Connected User Equipments, which is the number of user equipments connected to the base station; although it is a commonly used indicator, it cannot be used alone as the basis for load assessment.

Performance indicators may include, for example but not limited to: (1) Throughput, the amount of data successfully transmitted per unit of time, reflecting transmission efficiency; (2) Latency: the time required for data to travel from the transmitting end to the receiving end, which is directly related to the quality of real-time applications; (3) Signal to Interference plus Noise Ratio (SINR), a key parameter reflecting wireless link quality; and (4) Channel Quality Indicator (CQI): a channel quality indicator reported by the user, used for link modulation and resource scheduling decisions of the base station.

Through the combination of the aforementioned multi-dimensional indicators, the present system is able to establish a more granular and accurate base station operation assessment model, thereby: (1) effectively distinguishing between different types of load scenarios such as “high connection count but low resource usage” and “low connection count but high interference load”; (2) providing a foundation for intelligent energy-saving or traffic control decisions such as dynamic power adjustment, spectrum resource reallocation, and load balancing; (3) reducing the chances of misjudging a base station as idle or overloaded, and enhancing overall energy efficiency and service stability.

In summary, integrating multiple resource and performance indicators for observation is one of the core technical means for achieving intelligent energy-saving and resource scheduling in future 5G and even 6G wireless networks. Based on this concept, the present disclosure proposes a multi-dimensional, data-driven base station management method to overcome the problems of insufficient accuracy and real-time performance caused by the existing reliance on a single indicator, thereby achieving better network operation performance and energy efficiency.

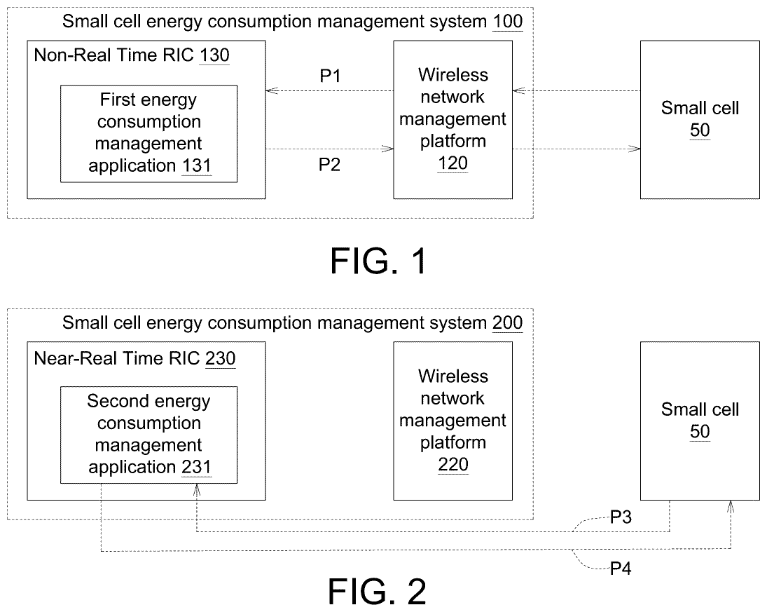

FIG. 1 illustrates a functional block diagram of an energy consumption management system for a small cell according to an embodiment of the present application. As shown in FIG. 1, the energy consumption management system 100 for a small cell is an energy consumption management system for a small cell based on an O-RAN (Open Radio Access Network) wireless network architecture, and receives multiple signals returned from a small cell (such as an integrated 5G small base station, or an All-In-One Cell) 50 to control the energy consumption of the small cell 50. The energy consumption management system 100 for a small cell includes: a wireless network management platform (such as a radio network controller, RNC) 120 and a Non-Real Time RIC (Radio Access Network (RAN) Intelligent Controller) 130. The Non-Real Time RIC 130 includes a first energy consumption management application 131.

The wireless network management platform (such as Radio Network Controller, RNC) 120 is responsible for the management and control of multiple wireless base stations (such as 5G small cells) in a traditional architecture, including: (1) base station management and control: coordinating resource allocation, power control, and signal connection; (2) Radio Resource Control (RRC): handling connection establishment, maintenance, and release between User Equipment (UE) and the network, and performing resource allocation and handover control; (3) Mobility Management: ensuring uninterrupted connection when a UE moves between multiple base stations; (4) encryption and security: providing data encryption and integrity protection; (5) Bearer Management: establishing different types of bearer channels according to service requirements to maintain Quality of Service (QoS); (6) core network connection: acting as a bridge between the Radio Access Network (RAN) and the Core Network (CN). Under the O-RAN (Open Radio Access Network) architecture, the real-time control functions of a traditional RNC have been decentralized to a Centralized Unit (CU) and a Distributed Unit (DU). The present wireless network management platform 120 is positioned at the Service Management and Orchestration (SMO) layer, focusing on network management and monitoring, with main functions including: (1) Configuration Management: centralized configuration and adjustment of network parameters; (2) Fault Management: real-time monitoring and reporting of abnormal statuses; (3) Performance Management: collecting and analyzing network performance indicators to support strategy optimization; (4) Software Management: version control and updates to ensure system stability. This wireless network management platform 120 does not directly perform the real-time control of a traditional RNC (such as power adjustment or handover), but rather assists operators in maintaining high performance and service quality in a multi-base station environment through centralized management and data analysis, and complies with the openness and interoperability of O-RAN standards.

In FIG. 1, various indicator signals transmitted from the small cell 50 are transmitted to the Non-Real Time RIC 130 through the wireless network management platform 120. Here, for example but not limited to, the various indicator signals transmitted from the small cell 50 are carried over multiple communication protocols: NETCONF (Network Configuration Protocol), used for configuring and managing network equipment; HTTP (HyperText Transfer Protocol), used for information transmission in network applications and being the standard protocol for communication between browsers and website servers; MQTT (Message Queuing Telemetry Transport), a lightweight real-time communication protocol designed for low-bandwidth, high-latency, or unstable network environments, commonly used for data transfer between Internet of Things (IoT) devices; and SNMP (Simple Network Management Protocol), used for monitoring and managing network equipment to obtain equipment status, performance data, fault notifications, etc.

The Non-Real Time RIC 130 is coupled to the wireless network management platform 120 and the first energy consumption management application 131. In other words, the wireless network management platform 120 is communicatively connected to the first energy consumption management application 131 of the Non-Real Time RIC 130 to receive various indicator signals transmitted from the wireless network management platform 120, as shown by signal path P1. In particular, the first energy consumption management application 131 determines the energy-saving operation of the small cell 50 according to the various indicator signals transmitted from the wireless network management platform 120 and a pre-established energy-saving strategy; and, the first energy consumption management application 131 sends an energy-saving control signal to the small cell 50 through the wireless network management platform 120 to control the energy-saving operation of the small cell 50, as shown by signal path P2. Specifically, the wireless network management platform 120 and the first energy consumption management application 131 are coupled to the Non-Real Time RIC 130 through an R1 interface customized and defined by O-RAN (Open Radio Access Network), the details of which will be described below.

FIG. 2 illustrates a diagram of an energy consumption management system for a small cell according to another embodiment of the present application. As shown in FIG. 2, the energy consumption management system 200 for a small cell is used to receive multiple signals returned from the small cell 50 to control the energy consumption of the small cell 50. The energy consumption management system 200 for a small cell includes: a wireless network management platform (such as radio network controller, RNC) 220 and a Near-Real Time RIC 230. The Near-Real Time RIC 230 includes a second energy consumption management application 231. In another embodiment, the energy consumption management system 100, 200 for a small cell may also simultaneously include the wireless network management platforms 120 and 220, the Non-Real Time RIC 130, and the Near-Real Time RIC 230. The Non-Real Time RIC 130 and the Near-Real Time RIC 230 may be collectively referred to as a “Radio Access Network Intelligent Controller.” In other words, the present disclosure can operate the energy consumption management application in the Non-Real Time RIC 130, the Near-Real Time RIC 230, or a parallel architecture of both, according to deployment requirements.

In FIG. 2, various indicator signals transmitted from the small cell 50 are directly transmitted to the second energy consumption management application 231 of the Near-Real Time RIC 230 (i.e., not through the wireless network management platform 220). Here, for example but not limited to, the various indicator signals transmitted from the small cell 50 are carried over Stream Control Transmission Protocol (SCTP), which is used for reliable transmission of network data (transport layer protocol), responsible for establishing multi-stream connections between two endpoints, and ensuring that data is delivered completely and in order. SCTP can communicate across multiple IP addresses and supports multi-homing function, enhancing the fault tolerance and stability of the connection.

The Near-Real Time RIC 230 is communicatively connected to the wireless network management platform 220 and the small cell 50, and directly receives various indicator signals transmitted from the small cell 50, as shown by signal path P3. In particular, the second energy consumption management application 231 determines the energy-saving operation of the small cell 50 according to the various indicator signals transmitted from the small cell 50 and a pre-established energy-saving strategy; and, the second energy consumption management application 231 directly sends an energy-saving control signal to the small cell 50 to control the energy-saving operation of the small cell 50, as shown by signal path P4.

In an embodiment of the present application, regardless of whether in FIG. 1 or FIG. 2, the various indicator signals collected by the small cell 50 include but are not limited to the following.

In a wireless access environment of a 5G or LTE network, assessing the load and operational status of the small cell 50 involves integrating multiple resource and performance indicators to obtain accurate and valuable analytical results. Among them, “PRB usage,” “Number of User Equipments (UEs),” and multiple KPIs (Key Performance Indicators) play key roles.

The PRB usage and available ratio can be used to reflect actual resource load. In an embodiment of the present application, a Physical Resource Block (PRB) is the most basic unit of time-frequency resource allocation. For each small cell, Downlink (DL) PRB usage and Uplink (UL) PRB usage are the core basis for judging the load status. In an embodiment of the present application, the DL/UL Total PRB Usage represents the number of PRBs actually allocated and used by the small cell in the downlink or uplink direction within a specific measurement period. These resources may be used for data transmission, control signaling, broadcast signals, etc. Additionally, DL/UL Available PRB represents the total number of PRBs available for scheduling and allocation by the system within the same measurement period. This number may be limited by modulation and coding schemes, bandwidth configuration, interference conditions, or equipment capabilities.

Through the ratio of PRB usage to availability (i.e., PRB usage rate), the resource usage density and real-time load conditions of the small cell can be directly reflected. When this ratio remains high for a long period, it may indicate that the small cell is in a state of high load or even a resource bottleneck, necessitating load balancing or resource optimization.

The Number of UEs is another load parameter used to represent the number of terminal devices currently connected to the base station. However, this number itself only has structural significance and cannot reflect the actual traffic load generated by each user.

In practice, the actual pressure generated on the base station by different user usage behaviors, application types, and communication characteristics varies greatly. For example: an area may simultaneously have hundreds of Internet of Things (IoT) devices, most of which only intermittently upload small amounts of data, placing extremely low demand on bandwidth and processing resources; conversely, if only a few users are performing high-resolution video streaming (such as 4K video) or VR applications, the required bandwidth and resources will be extremely substantial.

Therefore, a single indicator of the number of UEs cannot fully reflect the real-time load status of a base station. Only by combining its active level (Active/Idle Ratio), data rate, service type, etc., can the pressure generated on the base station be more truly evaluated.

Key Performance Indicators (KPIs) serve as a comprehensive reflection of load and quality. In an embodiment of the present application, in addition to resource usage and the number of UEs, multiple network performance indicators must also be observed, including but not limited to: (A) Throughput: representing the amount of data successfully transmitted per unit of time, which is a key indicator for measuring transmission efficiency; (B) Latency: the time delay of data from the transmitting end to the receiving end, which is highly correlated with user experience; (C) Signal to Interference plus Noise Ratio (SINR): reflecting the ratio of the received effective signal to interference and noise, which is a core parameter of communication link quality; (D) Channel Quality Indicator (CQI): a channel quality indicator reported by the UE, affecting the modulation and coding schemes adopted by the base station.

The aforementioned indicators can serve as the basis for the performance of the base station under actual load conditions. For example: in the case of a high number of UEs and high PRB usage, if the system can still maintain high throughput and low latency, it indicates good resource management capabilities and network scheduling strategies; if a significant decrease in SINR or CQI is observed simultaneously, it may be caused by excessive allocation of base station resources, high interference, or hardware bottlenecks, requiring real-time adjustment of network parameters or activation of load balancing mechanisms.

Therefore, in an embodiment of the present application, integrated observation is utilized to establish a comprehensive base station status model. Since a single parameter cannot accurately evaluate the operation and load status of a small cell, an embodiment of the present application performs integrated monitoring through multiple indicators (PRB usage rate, UE activity analysis, performance KPIs, etc.) in order to accurately construct a real-time load and performance model of the base station, predict potential overload risks, and precisely trigger energy-saving or scheduling mechanisms.

In an embodiment of the present application, to balance energy efficiency and quality of service, small cells typically perform dynamic adjustments of multiple radio parameters for different operational states and environmental conditions. The primary adjustment parameters considered in the present disclosure include: MIMO (Multiple Input Multiple Output) configuration, the number of Secondary Component Carriers (SCCs), PA (Power Amplifier) power settings, and Total transmit Power (Tx Power). The technical background of each parameter and the impact of its adjustment on the system are described respectively below.

Adjustment of MIMO configuration affects transmission rate and signal coverage. MIMO technology is one of the core technologies in modern wireless communication systems. Through spatial multiplexing and beamforming between multiple antennas, it can significantly enhance transmission capacity and signal quality. “4×4” MIMO represents the use of 4 transmitting and 4 receiving antennas, which has a higher spatial degree of freedom and can support multi-stream transmission. It is suitable for high-speed data downloads and complex urban areas, significantly improving data rates and coverage. “2×2” MIMO is a relatively simplified configuration with lower required processing resources and power consumption, making it particularly suitable for low-traffic periods or application scenarios with lower capacity requirements, which helps in energy-saving.

Therefore, in an embodiment of the present application, dynamically adjusting the MIMO configuration can achieve a balance between performance and energy consumption based on the current number of UEs, data load, and interference environment.

Adjustment of SCC (Secondary Component Carrier) configuration affects bandwidth usage and system capacity. In 5G systems, Carrier Aggregation (CA) technology allows carriers from multiple frequency bands to be integrated into one logical bandwidth to enhance overall transmission capacity and user experience. SCC refers to additional carriers besides the Primary Component Carrier (PCC) provided for users to perform high-bandwidth data transmission. When the system traffic load increases, enabling multiple SCCs can expand bandwidth resources and improve the throughput and quality of service for simultaneously connected users. However, enabling more SCCs will simultaneously increase power consumption, especially in high frequency bands where signal attenuation is faster and coverage is smaller, requiring higher power to support stable connections. Therefore, in an embodiment of the present application, dynamically adjusting the number of SCCs based on the number of users, bandwidth utilization, and application requirements can address both capacity expansion and energy-saving needs.

PA (Power Amplifier) power adjustment affects signal strength and coverage quality. The power amplifier is a key component of the base station transmitter, amplifying radio frequency signals to sufficient strength for wireless transmission. When the PA power setting is higher, the transmitted signal can have stronger penetration and coverage, providing better connection stability for UEs in long-distance or high-obstruction environments. However, high-power operation leads to a significant increase in power consumption and may generate excessive adjacent-channel interference. During low traffic, when users are concentrated or the environment is stable, appropriately reducing the PA power helps in energy-saving and reduces unnecessary interference. Therefore, in an embodiment of the present application, dynamic PA adjustment according to environmental conditions and coverage requirements is an important means of energy-saving design.

Tx Power (Total transmit Power) adjustment affects coverage area and interference control. Total transmit power is the overall RF transmit power setting of the base station, including the sum of all carriers and antenna outputs, which has a direct impact on system coverage and neighboring interference. High total transmit power can enhance coverage area and signal stability, aiding connection quality in remote or shielded areas, but it relatively increases power consumption and the risk of interference to neighboring cells. Low total transmit power helps reduce inter-cell interference (especially in dense deployment scenarios of small cells) and lowers unnecessary energy consumption, making it particularly suitable for user-concentrated or indoor application environments. Thus, in an embodiment of the present application, by monitoring user location distribution, connection quality, and SINR in real-time, the total transmit power is dynamically adjusted to achieve fine-grained control over cell coverage and interference boundaries, reaching optimization of performance and energy.

Embodiments of the present disclosure consider multiple adjustable parameters of a base station that affect energy consumption and performance, and integrate “spatial dimension control of MIMO configuration,” “spectrum dimension expansion of the number of SCCs,” “signal strength management of PA power,” and “coverage and interference optimization of total transmit power” to form a multi-dimensional, predictable, and intelligent energy-saving regulation architecture. This architecture can autonomously determine an optimal parameter combination based on real-time network load, user activity characteristics, and environmental changes, thereby enhancing the overall system energy efficiency and service quality.

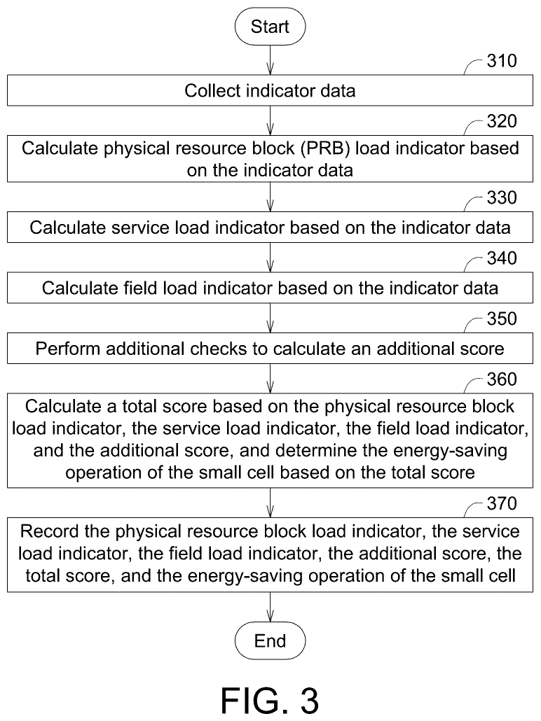

FIG. 3 shows a flowchart of an energy consumption management method for a small cell according to an embodiment of the present application.

In step 310, the small cell 50 collects indicator data for the energy consumption management system for a small cell (100 or 200). As shown in FIG. 1, the small cell 50 collects indicator data for the wireless network management platform 120, which is then transmitted to the first energy consumption management application 131; or, as shown in FIG. 2, the small cell 50 collects indicator data for the second energy consumption management application 231. Here, for example but not limited to, the indicator data collected by the small cell 50 includes the following: downlink available physical resource block parameter PRB_DL_total, uplink available physical resource block parameter PRB_UL_total, downlink used physical resource block parameter PRB_DL_used, and uplink used physical resource block parameter PRB_UL_used; a UE density indicator parameter (UE density) representing the number of terminal devices currently connected to the base station; throughput ratio parameters, including: downlink throughput parameter DRBUEThpDI and uplink throughput parameter DRBUEThpUI; SINR; Reference Signal Received Power (RSRP); Reference Signal Received Quality (RSRQ); CQI ratio parameters (UE.id.SINR, UE.id.RSRP, UE.id.RSRQ, UE.id.CQI); spatial ratio parameters (Spatial ratio), including: Field location and UE.id.location, etc.; cell status parameters (Cell status), including total transmit power (Tx power), center frequency, service time, neighbor relation, etc. That is, in an embodiment of the present application, the wireless network management platform 120 (FIG. 1) or the second energy consumption management application 231 (FIG. 2) receives the plurality of indicator data transmitted from the small cell 50.

In step 320, the first energy consumption management application 131 or the second energy consumption management application 231 calculates a physical resource block load indicator S1 based on the indicator data. In calculating the physical resource block load indicator (also referred to as a physical resource block (PRB) usage rate indicator) S1, a first PRB downlink score (also referred to as a downlink PRB usage rate) PRB_DL_Score and a first PRB uplink score (also referred to as an uplink PRB usage rate) PRB_UL_Score are calculated. Wherein, the definitions are as follows:

$$PRB\_DL \_Score = \frac{PRB\_DL \_used}{PRB\_DL \_total} ; PRB\_UL \_Score = \frac{PRB\_UL \_used}{PRB\_UL \_total} .$$

Here, PRB_DL_used, PRB_DL_total, PRB_UL_used, and PRB_UL_total represent the used downlink PRB, total downlink PRB, used uplink PRB, and total uplink PRB, respectively.

Accordingly, a second PRB downlink score SDL and a second PRB uplink score SUL can be obtained. Their definitions are as follows.

$${S}_{DL} = max ( 0 , min ( 1 , \frac{PRB\_DL \_Score - PRB\_DL {\_Score}_{min}}{PRB\_DL {\_Score}_{max} - PRB\_DL {\_Score}_{min}} ) )$$

$${S}_{UL} = max ( 0 , min ( 1 , \frac{PRB\_UL \_Score - PRB\_UL {\_Score}_{min}}{PRB\_UL {\_Score}_{max} - PRB\_UL {\_Score}_{min}} ) )$$

Wherein, PRB_DL_Scoreₘᵢₙ represents a preset minimum value (e.g., but not limited to 0.2) of the first PRB downlink score PRB_DL_Score, and PRB_DL_Scoreₘₐₓ represents a preset maximum value (e.g., but not limited to 0.9) of the first PRB downlink score PRB_DL_Score. Similarly, PRB_UL_Scoreₘᵢₙ represents a preset minimum value (e.g., but not limited to 0.2) of the first PRB uplink score PRB_UL_Score, and PRB_UL_Scoreₘₐₓ represents a preset maximum value (e.g., but not limited to 0.9) of the first PRB uplink score PRB_UL_Score.

Additionally, a PRB variable α is further set, wherein α∈[0,1], for example but not limited to α=0.7. The physical resource block load indicator is calculated according to the PRB variable α, the second PRB downlink score SDL, and the second PRB uplink score S_{UL}. The physical resource block load indicator can be expressed as: S₁=α×S_{DL}+(1−α)×S_{UL}. That is, the PRB variable α is a weighting coefficient between 0 and 1, used to combine a second uplink score and a second downlink score to generate said physical resource block usage rate indicator.

An example is given here for illustration. Suppose there are a total of 273 PRB blocks. Uplink (UL) and downlink (DL) usage situations are respectively calculated based on this number. Next, constraint conditions are applied for extreme cases (e.g., 20% or 90% usage). Finally, these usage values are normalized to a range between 0 and 1. To integrate UL and DL usage patterns, the parameter α is used to give corresponding weights to directions that need to be emphasized. Then,

$$PRB\_DL \_Score = \frac{205}{273} = 0.75 ;$$

$$PRB\_UL \_Score = \frac{123}{273} = 0.45 ;$$

$${S}_{DL} = max ( 0 , min ( 1 , \frac{0.75 - 0.2}{0.9 - 0.2} ) ) = 0.78 ;$$

$${S}_{UL} = max ( 0 , min ( 1 , \frac{0.45 - 0.2}{0.9 - 0.2} ) ) = 0.35 ;$$

$${S}_{1} = 0.7 \times 0.78 + ( 1 - 0.7 ) \times 0.35 = 0.65 .$$

In step 330, the first energy consumption management application 131 or the second energy consumption management application 231 calculates a service load indicator S2 based on the indicator data. The details of calculating the service load indicator S2 will now be described. A throughput downlink score TP_DL_Score and a throughput uplink score TP_UL_Score are calculated. Wherein, the definitions are as follows:

$$TP\_DL \_Score = min ( 1 , max ( 0 , 1 - \frac{{TP\_DL}_{now}}{{TP\_DL}_{hist}} ) ) ;$$

$$TP\_UL \_Score = min ( 1 , max ( 0 , 1 - \frac{{TP\_UL}_{now}}{{TP\_UL}_{hist}} ) ) .$$

Here, TP_DL_{now}, TP_DLₕᵢₛₜ, TP_UL_{now}, and TP_ULₕᵢₛₜ represent the current downlink throughput, historical downlink throughput, current uplink throughput, and historical uplink throughput, respectively.

Thereafter, a throughput score TP_Score (also referred to as a throughput indicator) is calculated according to a throughput parameter β, the throughput downlink score TP_DL_Score, and the throughput uplink score TP_UL_Score, which can be expressed as: TP_Score=β×TP_DL_Score+(1−β)×TP_UL_Score, wherein β∈[0,1], for example but not limited to β=0.7.

Additionally, an SINR score (also referred to as an SINR indicator) is calculated, expressed as:

$$SINR\_Score = min ( 1 , max ( 0 , 1 - \frac{S I N {R}_{now}}{S I N {R}_{max}} ) ) ,$$

wherein SINR_{now} represents the current SINR, and SINRₘₐₓ represents a maximum SINR value, such as but not limited to SINRₘₐₓ=30.

Additionally, a CQI score (also referred to as a CQI indicator) is calculated, expressed as:

$$CQI\_Score = min ( 1 , max ( 0 , 1 - \frac{{CQI}_{now}}{{CQI}_{max}} ) ) ,$$

wherein CQI_{now} represents the current CQI, and CQIₘₐₓ represents a maximum CQI value, such as but not limited to CQIₘₐₓ=15.

The service load indicator S₂ can be expressed as:

$${S}_{2} = {w}_{1} \times TP\_Score + {w}_{2} \times SINR\_Score + {w}_{3} \times CQI\_Score , {\sum }_{i = 1}^{3} {w}_{i} = 1.$$

An example is listed below for illustration.

$${w}_{1} = 0.5 , {w}_{2} = 0.3 , {w}_{3} = 0.2 .$$

$$TP\_DL \_Score = min ( 1 , max ( 0 , 1 - \frac{40}{60} ) ) = 0.33 .$$

$$TP\_UL \_Score = min ( 1 , max ( 0 , 1 - \frac{10}{20} ) ) = 0.5 .$$

$$TP\_Score = 0.7 \times 0.33 + 0.3 \times 0.5 = 0.38 .$$

$$SINR\_Score = min ( 1 , max ( 0 , 1 - \frac{20}{30} ) ) = 0.33 .$$

$$CQI\_Score = min ( 1 , max ( 0 , 1 - \frac{10}{15} ) ) = 0.33 .$$

$${S}_{2} = 0.5 \times 0.38 + 0.3 \times 0.33 + 0.2 \times 0.33 = 0.35 .$$

In other words, in step 330, historical uplink (UL) and downlink (DL) throughput performances are obtained to calculate the current usage. To integrate UL and DL patterns, the parameter β is used to give corresponding weights to directions that need to be emphasized. According to 3GPP standards, the range of SINR (Signal to Interference plus Noise Ratio) is 0 to 30 dBm, and the ratio of current performance relative to the optimal state is calculated accordingly. According to 3GPP standards, the range of CQI (Channel Quality Indicator) is 0 to 15, and the ratio of current performance relative to the optimal state is calculated accordingly. To integrate these service-related parameters, a parameter “w” is used to give corresponding weight to each parameter.

In step 340, the first energy consumption management application 131 or the second energy consumption management application 231 calculates a field load indicator S₃ based on the indicator data. Here, a UE score UE_Score and an area score Area_Score are calculated.

$$UE\_Score = min ( 1 , max ( 0 , \frac{U {E}_{now}}{U {E}_{max}} ) ) ;$$

$$Area\_Score = min ( 1 , max ( 0 , \frac{{Area}_{now}}{{Area}_{max}} ) ) .$$

Wherein UE_{now}, UEₘₐₓ, Area_{now}, and Areaₘₐₓ represent the current number of UE connections, the maximum number of UE connections, the current service coverage area of a base (e.g., but not limited to, in square kilometers), and the maximum service coverage area of a base (in square kilometers), respectively.

The field load indicator S₃ can be expressed as: S₃=γ×UE_Score+δ×Area_Score; γ,δ∈[0,1]; γ+δ=1.

An example is given here for illustration.

$$UE\_Score = min ( 1 , max ( 0 , \frac{180}{300} ) ) = 0.6 ;$$

$$Area\_Score = min ( 1 , max ( 0 , \frac{0.25}{1} ) ) = 0.25 ;$$

$${S}_{3} = 0.7 \times 0.6 + 0.3 \times 0.25 = 0.495 .$$

In other words, in an embodiment of the present application, the first energy consumption management application 131 or the second energy consumption management application 231 calculates a load parameter based on the indicator data of the small cell 50. The load parameter comprises at least one of: (1) a physical resource block (PRB) usage rate indicator calculated based on an uplink PRB usage rate and a downlink PRB usage rate of the small cell; (2) a service load indicator calculated based on current throughput data and historical throughput data of the small cell; (3) a field load indicator calculated based on a user equipment connection ratio and a service area ratio; and (4) an additional indicator calculated based on a total transmit power ratio, a service time ratio, and a handover availability parameter.

In step 340, a maximum number of UE connections is set for the cell, and the connection ratio (also referred to as the user equipment connection ratio) of the current number of UE connections relative to the extreme case is calculated; a maximum service coverage area (in square kilometers) is set for the cell, and the area ratio (also referred to as the service area ratio) of the current service area relative to the extreme case is calculated. To integrate these field-related parameters, two independent parameters γ and δ are used and weights are assigned to them respectively.

In step 350, an additional check is performed by the first energy consumption management application 131 or the second energy consumption management application 231 to calculate an additional score S4. For example, a total transmit power score Tx_Score, a service score Service_Score, and a handover score Handover_Score (also referred to as a “handover availability parameter”) are additionally calculated, wherein

$$Tx\_Score = min ( 1 , max ( 0 , \frac{{Tx}_{now}}{{Tx}_{max}} ) ) ;$$

$$Service\_Score = min ( 1 , max ( 0 , \frac{Service\_time}{{Service\_time}_{max}} ) ) .$$

TX_{now}, TXₘₐₓ, Service_time, and Service_timeₘₐₓ represent the current total transmit power, the maximum total transmit power, the current served time, and the maximum served time, respectively.

When there is a neighboring small cell available for handover (i.e., determining whether a handover to a neighboring base station is possible), the handover score is 1, otherwise it is 0.

$${S}_{4} = {w}_{4} \times Tx\_Score + {w}_{5} \times Service\_Score + {w}_{6} \times Handover\_Score ; {w}_{i} ∈ [ 0 , 1 ] ; and {\sum }_{i = 4}^{6} {w}_{i} = 1.$$

An example is listed for illustration.

$$Tx\_Score = min ( 1 , max ( 0 , \frac{21}{22} ) ) = 0.95 ;$$

$$Service\_Score = min ( 1 , max ( 0 , \frac{24 \times 7}{24 \times 14} ) ) = 0.5 ;$$

$$Handover\_Score = 1 ;$$

$${S}_{4} = 0.5 \times 0.95 + 0.3 \times 0.5 + 0.2 \times 1 = 0.82 .$$

In step 350, transmit power and cell service time also affect the overall performance of the cell. Therefore, the ratio of current transmit power relative to the maximum transmit power condition (also referred to as the total transmit power ratio) is calculated; simultaneously, the ratio of current service time relative to the service time corresponding to the best performance (also referred to as the service time ratio) is calculated. It is determined whether a neighboring cell available for handover exists for the cell (handover score); if so, the cell can switch to an energy-saving mode. To integrate these additional check indicators, parameters “w” are used to assign corresponding weights to the importance of each indicator.

In step 360, a total score Total_score (also referred to as an overall load parameter) is calculated by the first energy consumption management application 131 or the second energy consumption management application 231 based on the physical resource block load indicator S1, the service load indicator S₂, the field load indicator S₃, and the additional score S4, and the energy-saving operation of the small cell is determined based on the total score. The total score Total_score can be expressed as follows: Total_score=w₇×S₁+w_{g}×S₂+w₉×S₃+w₁₀×S₄. Wherein wᵢ∈[0,1], and

$${\sum }_{i = 7}^{10} {w}_{i} = 1.$$

S₁~S₄ may also be collectively referred to as a load vector (or load parameters). The overall load parameter is calculated based on a loss function, the loss function including a weighted sum of each indicator in the load vector. That is, in an embodiment of the present application, the first energy consumption management application 131 or the second energy consumption management application 231 performs numerical normalization and weighting based on the load parameters to calculate an overall load parameter.

An example is given for illustration. S₁=0.65; S₂=0.35; S₃=0.495; S₄=0.82; w₇=0.3; w₈=0.3; w₉=0.25; w₁₀=0.15. Total_score=0.3×0.65+0.3×0.35+0.25×0.495+0.15×0.82=0.54.

In an embodiment of the present application, the energy-saving operation of the small cell is determined based on the total score. For example but not limited to, when the total score is lower than a first threshold (e.g., but not limited to 0.33), it is determined that the current small cell belongs to a low load, and thus the small cell can be made to enter deep energy-saving. When the total score is higher than the first threshold but lower than a second threshold (e.g., but not limited to 0.66), it is determined that the current small cell belongs to a medium load, and thus the small cell can be made to enter light energy-saving. When the total score is higher than the second threshold, it is determined that the current small cell belongs to a high load, and thus the small cell can be made to enter normal operation (i.e., no energy-saving). That is, in an embodiment of the present application, the energy-saving states of the small cell include: a deep energy-saving state, a light energy-saving state, and a normal operation state. In other words, in an embodiment of the present application, the first energy consumption management application 131 or the second energy consumption management application 231 controls the small cell 50 to enter an energy-saving state based on the overall load parameter.

In step 370, the physical resource block load indicator S₁, the service load indicator S₂, the field load indicator S₃, the additional score S₄, the total score Total_score, and the energy-saving operation of the small cell are recorded by the first energy consumption management application 131 or the second energy consumption management application 231.

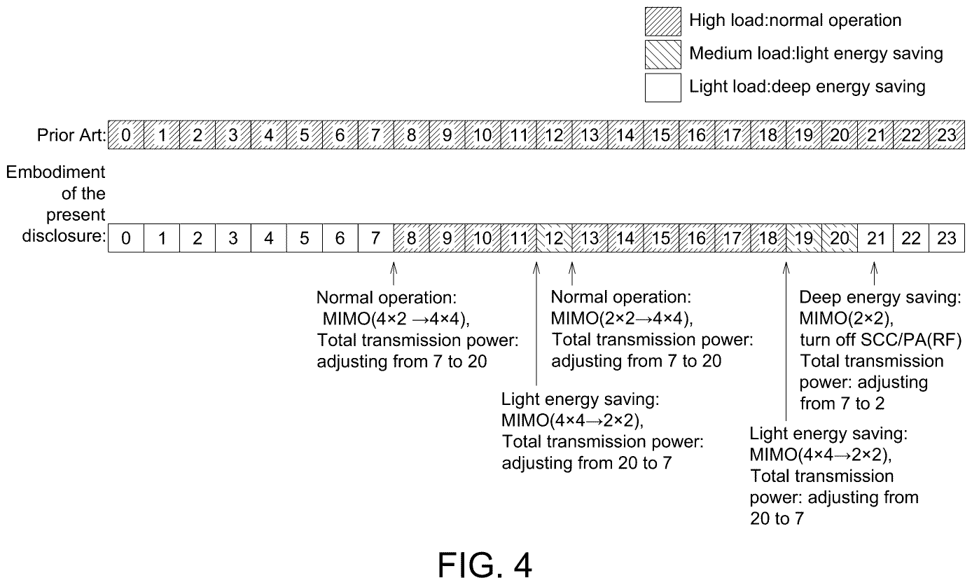

FIG. 4 shows a schematic diagram of energy-saving of a small cell according to an embodiment of the present application. As shown in FIG. 4, in the prior art, from 0 to 23 o'clock, the small cell is always in normal operation because no energy-saving operation is performed. Conversely, in an embodiment of the present application, for example, an energy-saving method is executed once every hour to calculate the total score to determine the current load condition of the small cell, thereby deciding the energy-saving operation. In an embodiment of the present application, after the energy-saving operation, from 21 o'clock the previous night to 7 o'clock, the system determines that the current small cell is in a light load condition, thereby controlling the small cell to be in deep energy-saving, such as but not limited to, MIMO set to 2×2, turning off SCC and PA, and changing the total transmit power from 7 (dBm) to 2 (dBm); from 8 to 11 o'clock, the system determines that the current small cell is in a high load condition, thereby controlling the small cell to be in normal operation, such as but not limited to, MIMO set to 4×4 and changing the total transmit power to 20 (dBm); at 12 o'clock, the system determines that the current small cell is in a medium load condition, thereby controlling the small cell to be in light energy-saving, such as but not limited to, MIMO set to 2×2 and changing the total transmit power to 7 (dBm); from 13 to 18 o'clock, the system determines that the current small cell is in a high load condition, thereby controlling the small cell to be in normal operation, such as but not limited to, MIMO set to 4×4 and changing the total transmit power to 20 (dBm); from 19 to 20 o'clock, the system determines that the current small cell is in a medium load condition, thereby controlling the small cell to be in light energy-saving, such as but not limited to, MIMO set to 2×2 and changing the total transmit power to 7 (dBm). That is, in an embodiment of the present application, the energy-saving state is achieved by adjusting at least one base station parameter, the base station parameter comprising at least one of: a Multiple Input Multiple Output (MIMO) mode; a number of secondary component carriers; a power amplifier output power; and a total transmit power setting value.

Embodiments of the present application can be applied to various fields, such as but not limited to, factories, campuses, department stores, stadiums, etc.

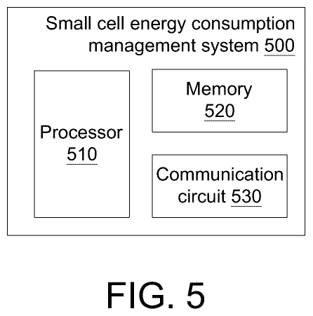

FIG. 5 shows a functional block diagram of an energy consumption management system for a small cell according to an embodiment of the present application. The energy consumption management system 500 for a small cell according to an embodiment of the present application can be used to implement the energy consumption management system 100 or 200 for a small cell of FIG. 1 or FIG. 2.

The energy consumption management system 500 for a small cell according to an embodiment of the present application includes: a processor 510, a memory 520, and a communication circuit 530. Of course, the energy consumption management system 500 for a small cell further includes other components.

The processor 510 is coupled to the memory 520 and the communication circuit 530. The communication circuit 530 can receive various indicator signals transmitted from the small cell and transmit and temporarily store them in the memory 520. When an energy-saving operation needs to be performed, the processor 510 receives the various indicator signals transmitted from the small cell retrieved from the memory 520, performs energy-saving calculations (such as after generating a total score), and generates a control signal accordingly to be sent back to the small cell to control the small cell to perform the energy-saving operation. That is, the processor 510 can execute the first energy consumption management application 131 and/or the second energy consumption management application 231 to complete the energy-saving method of the above embodiments.

On this basis, the present disclosure proposes a multi-dimensional, prediction-oriented, and intelligent base station management architecture, achieving higher energy efficiency and a more stable user experience by analyzing multiple key parameters in real-time.

Through the above architecture, the present disclosure is able to establish a multi-dimensional, dynamic, and forward-looking energy-saving control method, achieving the following benefits: (1) intelligent energy-saving control: dynamically adjusting power, timing, and resource allocation for the actual operation scenario of each base station, reducing energy waste in idle states; (2) maintaining Quality of Service (QoS): performing energy-saving without sacrificing user experience, such as avoiding problems like packet delay and channel handover failure caused by excessive energy-saving; (3) supporting green network deployment: by reducing overall energy consumption and carbon emissions, complying with energy-saving and carbon-reduction policies and Green ICT development goals; (4) applicable to multiple deployment scenarios: capable of adjusting according to different load patterns regardless of different environments such as indoor, outdoor, commercial offices, and transportation hubs.

Overall, the system and method proposed by the present disclosure break through the limitations of the prior art, achieving an energy management architecture for small cells that balances intelligence, precision, and sustainable development, effectively enhancing energy usage efficiency and addressing the growing deployment and operation needs of 5G networks.

The foregoing primarily describes the solutions provided in the embodiments of the present application from the perspective of the interaction between small cells and management systems. It can be understood that, to implement the above functions, the small cells and management systems include corresponding hardware structures and/or software modules for executing functions. Professionals in the technical field should easily realize that, in combination with the units and algorithm steps of the embodiments described in this specification, the present application can be implemented in the form of hardware or a combination of hardware and computer software. Whether a function is executed by hardware or hardware driven by computer software depends on the specific application and design constraints of the technical solution. Professionals in the technical field can use different methods to implement the functions described for each specific application, but such implementation should not be considered beyond the scope of the present application.

Although many specific details may be described in this application, these should not be interpreted as limitations on the scope of the claimed invention, but rather as descriptions of characteristics of specific embodiments. In the description of this application, certain characteristics described in the context of a single embodiment can also be implemented in combination in a single embodiment. Conversely, various characteristics described in the context of a single embodiment can also be implemented in multiple embodiments individually or in any appropriate sub-combination. Furthermore, although characteristics may initially be described as functioning in certain combinations, or even initially illustrated as such combinations, in some cases, one or more characteristics can be deleted from that combination, and the illustrated combination may be directed to a sub-combination or variations of a sub-combination. Similarly, although operations are depicted in the drawings in a specific order, this should not be understood as requiring that these operations must be performed in the specific order or sequence shown, or that all depicted operations must be performed to achieve desired results.

Although the above embodiments of the present application only disclose some examples and implementation modes. Based on the disclosed content, changes, modifications, and enhancements can be made to the described examples and implementation modes as well as other implementation modes.

In summary, although the present disclosure has been disclosed in the above embodiments, they are not intended to limit the present disclosure. Those with ordinary knowledge in the technical field to which the present disclosure belongs can make various changes and refinements without departing from the spirit and scope of the present disclosure. Therefore, the protection scope of the present disclosure shall be determined by the scope of the appended claims.

What is claimed is:

1. An energy consumption management method for a small cell, the energy consumption management method comprising:
receiving a plurality of indicator data of the small cell;
calculating a load parameter, the load parameter comprising at least one of: a physical resource block (PRB) usage rate indicator calculated according to an uplink PRB usage rate and a downlink PRB usage rate of the small cell; a service load indicator calculated according to current throughput data and historical throughput data of the small cell; a field load indicator calculated according to a user equipment connection ratio and a service area ratio; and an additional indicator calculated according to a total transmit power ratio, a service time ratio, and a handover availability parameter;
performing numerical normalization and weighting based on the load parameter to calculate an overall load parameter; and
controlling the small cell to enter an energy-saving state according to the overall load parameter.

2. The energy consumption management method according to claim 1, wherein the overall load parameter is calculated according to a loss function, the loss function comprising a weighted sum of each indicator in the load parameter.

3. The energy consumption management method according to claim 1, wherein the energy-saving state comprises a deep energy-saving state, a light energy-saving state, and a normal operation state.

4. The energy consumption management method according to claim 3, wherein:
controlling the small cell to enter the deep energy-saving state when the overall load parameter is lower than a first threshold;
the small cell enters the light energy-saving state when the overall load parameter is higher than the first threshold and lower than a second threshold; and
the small cell enters the normal operation state when the overall load parameter is higher than the second threshold.

5. The energy consumption management method according to claim 1, wherein the energy-saving state is achieved by adjusting at least one small cell parameter, the small cell parameter comprising at least one of: a Multiple Input Multiple Output (MIMO) mode; a number of secondary component carriers; a power amplifier output power; and a total transmit power setting value.

6. The energy consumption management method according to claim 1, wherein calculating the physical resource block usage rate indicator is derived according to a used downlink PRB, an available downlink PRB, a used uplink PRB, an available uplink PRB, a first PRB downlink score minimum value, a first PRB downlink score maximum value, a first PRB uplink score minimum value, a first PRB uplink score maximum value, and a preset PRB variable.

7. The energy consumption management method according to claim 6, wherein the PRB variable is a weighting coefficient between 0 and 1, used to combine a second uplink score and a second downlink score to generate the physical resource block usage rate indicator.

8. The energy consumption management method according to claim 1, wherein calculating the service load indicator is generated according to a throughput indicator, a Signal to Interference plus Noise Ratio (SINR) indicator, and a Channel Quality Indicator (CQI).

9. The energy consumption management method according to claim 8, wherein:
the throughput indicator is generated according to a current downlink throughput, a current uplink throughput, a historical downlink throughput, and a historical uplink throughput;
the SINR indicator is generated according to a current SINR and a maximum SINR value; and
the CQI indicator is generated according to a current CQI and a maximum CQI value.

10. The energy consumption management method according to claim 1, wherein in calculating the field load indicator:
the user equipment connection ratio is calculated according to a current number of user equipment connections and a maximum number of user equipment connections; and
the service area ratio is calculated according to a current service coverage area of a base and a maximum service coverage area of a base.

11. The energy consumption management method according to claim 1, wherein in calculating the additional indicator:
the total transmit power ratio is calculated according to a current total transmit power and a maximum total transmit power;
the service time ratio is determined according to a current served time and a maximum served time; and
the handover availability parameter is a first value when a neighboring small cell is available for handover, and is a second value otherwise.

12. A small cell energy consumption management system communicatively connected to a plurality of small cells, the energy consumption management system comprising:
a radio access network intelligent controller, comprising an energy consumption management application; and
a wireless network management platform, communicatively connected to the radio access network intelligent controller or the energy consumption management application;
wherein the energy consumption management application receives a plurality of indicator data of the plurality of small cells to calculate a load parameter of the plurality of small cells, and weights the load parameter to respectively calculate a plurality of overall load parameters of the plurality of small cells, whereby the energy consumption management application controls the corresponding plurality of small cells to enter an energy-saving state according to each of the overall load parameters.

13. The small cell energy consumption management system according to claim 12, wherein the radio access network intelligent controller is a non-real-time radio access network intelligent controller, communicatively connected to the plurality of small cells through the wireless network management platform.

14. The small cell energy consumption management system according to claim 12, wherein the radio access network intelligent controller is a near-real-time radio access network intelligent controller, directly and communicatively connected to the plurality of small cells.

15. The small cell energy consumption management system according to claim 12, wherein the load parameter comprises at least one of a physical resource block (PRB) usage rate indicator, a service load indicator, a field load indicator, and an additional indicator.

16. The small cell energy consumption management system according to claim 15, wherein the plurality of indicator data comprises an uplink PRB usage rate and a downlink PRB usage rate of the plurality of small cells, and the energy consumption management application calculates the physical resource block usage rate indicator of the plurality of small cells according to the uplink PRB usage rate and the downlink PRB usage rate.

17. The small cell energy consumption management system according to claim 15, wherein the plurality of indicator data comprises current throughput data and historical throughput data of the plurality of small cells, and the energy consumption management application calculates the service load indicator of the plurality of small cells according to the current throughput data and the historical throughput data.

18. The small cell energy consumption management system according to claim 15, wherein the plurality of indicator data comprises a user equipment connection ratio and a service area ratio of the plurality of small cells, and the energy consumption management application calculates the field load indicator of the plurality of small cells according to the user equipment connection ratio and the service area ratio.

19. The small cell energy consumption management system according to claim 15, wherein the plurality of indicator data comprises a total transmit power ratio, a service time ratio, or a handover availability parameter of the plurality of small cells, and the energy consumption management application calculates the additional indicator of the plurality of small cells according to the total transmit power ratio, the service time ratio, or the handover availability parameter.
